(19) United States
(12) Patent Application Publication
(10) Pub. No.: US 2010/0250922 A1
(43) Pub. Date: Sep. 30, 2010

(54) METHOD AND SYSTEM FOR PROPAGATING TRUST IN AN AD HOC WIRELESS COMMUNICATION NETWORK

(75) Inventors: Qi Bao, Westborough, MA (US); Donald E. Eastlake, III, Milford, MA (US); Liang Guo, Waltham, MA (US); Whay Chiou Lee, Cambridge, MA (US)

Correspondence Address: MOTOROLA, INC, 1303 EAST ALGONQUIN ROAD, IL01/3RD, SCHAUMBURG, IL, 60196, US

(73) Assignee: Motorola, Inc., SCHAUMBURG, IL (US)

(21) Appl. No.: 12/415,640

(22) Filed: Mar. 31, 2009

(51) Int. Cl. H04L 9/00

(52) U.S. Cl. 713/158; 713/156

(57) ABSTRACT

A method and system enable robust and scalable propagation of trust between a first organization and a second organization, both operating in an ad hoc wireless communication network. The method includes establishing at a first member node of the first organization pair-wise trust with a first member node of the second organization using a predetermined inter-organizational trust establishment device (step 505). Next, the first member node of the first organization generates a credential for the second organization using the pair-wise trust (step 510). The credential is then distributed from the first member node of the first organization to a second member node of the first organization (step 515). The second member node of the first organization then establishes pair-wise trust with a second member node of the second organization using the credential received from the first member node of the first organization (step 520).

### FIELD OF THE DISCLOSURE

The present invention relates generally to wireless communication networks, and in particular to establishing trust among devices having certificates signed by different certification authorities in an ad hoc wireless communication network.

### BACKGROUND

Many wireless communication environments require a rapid deployment of independent mobile users as well as reliable communications between user devices. Mesh networks are often ideal in such environments and are based on self-configuring autonomous collections of portable devices. A mesh network is a collection of wireless user devices, also referred to as nodes, organized in a decentralized manner to provide range extension by allowing the nodes to be reached across multiple hops. In a mesh network, communication packets sent by a source node thus can be relayed through one or more intermediary nodes before reaching a destination node. Mesh networks may be deployed as temporary packet radio networks that do not involve significant, if any, supporting infrastructure. Rather than employing fixed base stations, in some mesh networks each user node can operate as a router for other user nodes, thus enabling expanded network coverage that can be set up quickly, at low cost, and which is highly fault tolerant. In some mesh networks, special wireless routers also may be used as intermediary infrastructure nodes. Large networks thus can be realized using intelligent access points (IAPs), also known as gateways or portals, which provide wireless nodes with access to a wired backhaul or wide area network (WAN).

Mesh networks can provide critical communication services in various environments involving, for example, emergency services at incident scenes supporting police and fire personnel, military applications, industrial facilities and construction sites. Mesh networks are also used to provide communication services in areas with little or no basic telecommunications or broadband infrastructure, and in areas with demand for high speed services (e.g., universities, corporate campuses, and dense urban areas). Multiple autonomous organizations may be involved in a mesh network and each organization may deploy a large number of wireless devices.

To establish secure communications between a pair of nodes, the nodes often have to first establish a trust relationship between them. A first node can trust a second node if the second node is able to present a credential that can be reliably verified by the first node. When the credentials of both nodes are mutually verified by each other, there is said to be a trust link established between the nodes. Once a trust link is established, additional handshakes between the nodes can be used to enable secure communications over an open communication path, which could be a direct link or a link that traverses one or more intermediate nodes.

Establishing trust links between nodes in a mesh communication network can be more difficult and complex than establishing trust links in wired networks and convention cellular networks. Unlike nodes in a mesh communication network, nodes in wired networks and conventional mobile devices such as cellular phones often obtain communication security using infrastructure-based authentication processes. According to conventional public key infrastructure (PKI) methods, two infrastructure-based communication nodes performing a mutual authentication process may each have a certificate signed by a different certification authority (CA) and received a priori by a trust anchor, which is a CA certificate containing a public key for certificate verification. Nevertheless, the signing CAs of a local node and a remote node may be the same as or different from the trust anchor CAs of the local node and the remote node. In order to authenticate a remote node, a certificate trust path often must be established between a remote node's signing CA and at least one of a local node's trust anchor CAs. Therefore, conventional PKI methods for infrastructure-based communication nodes often provide a centralized authority, such as a public key directory, that can be queried for public key certificates.

Existing solutions for establishing inter-organizational trust typically rely on cross certification between CAs directly or via a bridge CA. These solutions thus require connectivity to infrastructure for certificate verification. However, nodes in mobile ad hoc networks are sometimes not connected to infrastructure. Thus nodes in mobile ad hoc networks may not be able to authenticate each other if the nodes have different signing CAs. Furthermore, such cross certification solutions provision inter-organizational trust a priori on a blanket basis. They are hence not robust as they may unnecessarily allow members of one organization to establish trust with those in the other organization even though the members in the other organization do not have any justifiable need for such trust extension (e.g., those who are not deployed at an incident scene).

Other methods for establishing inter-organizational trust utilize a device, known as a trust bridge, for establishing a trust link between two members of different organizations in an ad hoc network. However, such methods generally do not scale well because they establishes inter-organizational trust for only one pair of members at a time.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating requirements for establishing trust between nodes of two different organizations in an ad hoc wireless communication network.

FIG. 2 is a diagram illustrating interactions for establishing trust between nodes of two different organizations in an ad hoc wireless communication network, according to some embodiments.

FIG. 3 is a diagram illustrating alternative interactions for establishing trust between nodes of two different organizations in an ad hoc wireless communication network, according to some embodiments.

FIG. 4 is a block diagram illustrating components of a device that functions as a member node in an ad hoc wireless communication network, according to some embodiments.

FIG. 5 is a general flow diagram illustrating a method for propagating trust between a first organization and a second organization operating in an ad hoc wireless communication network, according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

According to some embodiments, the present invention includes a method for propagating trust between a first organization and a second organization, both operating in an ad hoc wireless communication network. The method includes establishing at a first member node of the first organization pair-wise trust with a first member node of the second organization using a predetermined inter-organizational trust establishment device. Next, the first member node of the first organization generates a credential for the second organization using the pair-wise trust. The credential is then distributed from the first member node of the first organization to a second member node of the first organization. The second member node of the first organization then establishes pair-wise trust with a second member node of the second organization using the credential received from the first member node of the first organization.

Embodiments of the present invention thus enable establishment of trust among devices having certificates signed by different certification authorities in an ad hoc wireless communication network in a scalable and robust manner. Specifically, after any two devices of different organizations have established trust between them by using an inter-organizational trust establishment device (e.g., a trust bridge), the method enables such trust to be extended to their respective organization member population subject to predetermined policy. The method leverages trust bridging as well as localized cross-certification and key distribution mechanisms to establish inter-organizational trust between members of two autonomous organizations.

As known by those having ordinary skill in the art, public key infrastructure (PKI) systems can be used to enable mobile devices to authenticate one another. In a general asymmetric cryptographic system, encryption and decryption of data are performed using a pair of different keys, where one key (known as a private key) is kept secret and another key (known as a public key) is safely divulged as needed. In a PKI system, there is at least one trusted entity, known as a certification authority (CA), which issues data structures (referred to as certificates) that bind specific identities to specific public keys and usage information via digital signatures. The CAs are trusted a priori based on their public keys that are known to be bound to their respective identities in advance. Entities other than CAs may establish trust among themselves by showing one another their respective certificates issued by trusted CAs. There may be a plurality of CAs in a given PKI domain, wherein the CAs may have a hierarchical or a meshed relationship among them. Trust relationships among CAs can be used to build a certification path, which is a chain of certificates where each certificate in the chain is validated by using its preceding certificate's public key. A certification path must terminate with a certificate of a CA that is trusted by a relying party (i.e., a certificate verifier), so that the relying party can verify, using a trusted public key (i.e., the public key associated with a trust anchor of the verifier), a certificate at the other end of the certification path.

As described above, when a certificate is produced by an entity (referred to as a target) to demonstrate proof of possession of a valid public key corresponding to the target's secret key, a verifier of the certificate needs to construct a certification path linking the verifier's trust anchor to the CA that has signed the certificate. However, in a multi-organizational environment, where each organization has its own PKI domain, applications supporting inter-organizational security require additional mechanisms to establish cross-organizational trust relationships, since certification paths normally remain within respective PKI domains.

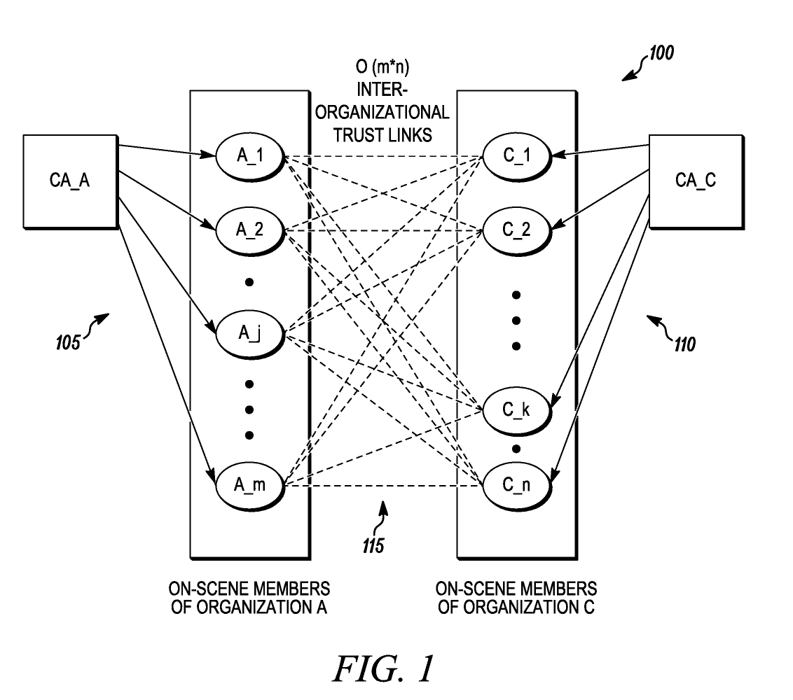

Referring to FIG. 1, a diagram illustrates requirements for establishing trust between nodes of two different organizations in an ad hoc wireless communication network 100. As illustrated, a first organization A has members A_1 to A_m and a second organization C has members C_1 to C_n deployed at an incident scene. Organization A has a certification authority CA_A to issue certificates, as shown by arrows 105, to all members in organization A; and organization C has a certification authority CA_C to issue certificates, as shown by arrows 110, to all members in organization C. Thus, every member of each organization has a certificate that can be used by any relying party from the same organization to validate the member's identity and a corresponding public key. A need remains for every member of each organization to have a certificate that can be used by any relying party from the other organization to validate the member's identity and a corresponding public key. In other words, there is a need to establish an inter-organizational trust link between each pair of members from different organizations.

It will be appreciated by those of ordinary skill in the art that there are altogether m*n inter-organizational trust links, illustrated by lines 115, between pairs of devices in different organizations. Hence, a mechanism that establishes inter-organizational trust links on a pair-by-pair basis will scale as O(m*n). Further, overall populations of organization A and organization C can be considerably larger than m and n, respectively. Hence, a mechanism that provisions inter-organizational trust a priori on a blanket basis could unnecessarily enable considerably more than m*n pair-wise secure connections.

Also, where a trusted communication path needs to traverse an organization boundary, methods exist for establishing trust between parties in different organizations including the use of cross certification (directly or indirectly via a bridge CA) between two root CAs, or the use of a trust bridge to establish an inter-organization trust link for each pair of communicating parties.

With cross certification, certificates of root CAs are cross-signed directly by each other, or by a bridge CA acting as an intermediary, such that devices from the two organizations can use their respective root CAs' certificates as trust anchors and verify each other's certificates. However, in a dynamic environment it is impractical to define a priori an appropriate range and terms that each cross-signed certificate should cover for various potential participating organizations. In addition, typically only a fraction of the overall population of an organization has valid justification for establishing inter-organizational trust (e.g., being at an incident scene). Cross certification can thus unnecessarily establish inter-organizational trust between members of two organizations even though they have no justification for establishing such trust (e.g., being not deployed at an incident scene).

In the trust bridge approach, a predetermined node is designated a priori to be an inter-organization trust establishment device configured with a predetermined set of trust anchors associated with different organizations and a certificate signed by a CA of each organization. The trust bridge then can be used to facilitate establishment of a trust link between a selected pair of nodes in different organizations. Specifically, the nodes first present to the trust bridge their certificates signed by their respective CAs. The trust bridge then verifies each of these certificates using a public key contained in the appropriate trust anchor. Upon verification, a trust link is established between the trust bridge and each of the nodes. With these trust links, the bridge is able to securely issue appropriate keying material to the nodes, wherein said keying material can be used by the nodes to enable secure communications between them. Since the nodes are able to verify each other's certificate through the trust bridge, an inter-organizational trust link is thus established between the nodes. However, this approach has limited scalability since it establishes inter-organizational trust for only one pair of devices at a time. Specifically, if there is a need for communication between every pair of devices in two organizations, the total number of trust bridge services requested is equal to an order of a product of the membership sizes of the two organizations. As a result, the load at a trust bridge could be very heavy at a large-scale incident scene involving many possible communicating parties from many diverse organizations. In addition, a trust bridge is a single point of potential network failure and can thus render a network less robust.

Yet another method is the Institute of Electrical and Electronics Engineers (IEEE) 802.1X Relay method. (For any IEEE standards recited herein, see: http://standards.ieee.org/getieee802/index.html or contact the IEEE at IEEE, 445 Hoes Lane, PO Box 1331, Piscataway, N.J. 08855-1331, USA.) IEEE 802.1X is an IEEE standard for port-based network access control, wherein device authentication is based on an Extensible Authentication Protocol (EAP). EAP is a protocol used to pass authentication information between a node (known as a supplicant) and an authentication server via a third party (known as an authenticator). IEEE 802.1X Relay further comprises steps of relaying authentication credentials between a supplicant and an authentication server, both of a first organization, by a node (i.e., authenticator) of a second organization, which has established a priori a trust link with the authentication server. With these steps, the authentication server is able to authenticate the supplicant. Subsequently, the supplicant and the authenticator can rely on the authentication server to verify each other's certificate, thereby establishing an inter-organizational trust link between them. The authentication server may further issue appropriate keying material to the supplicant and the authenticator in order to enable secure communications between them. The IEEE 802.1X Relay method improves system scalability in terms of authentication load distribution by employing an inter-organizational authentication process as a by-product of an intra-organizational 802.1X based authentication process. However, the efficiency of the method is topology dependent. Specifically, in order to use 802.1X Relay to establish an inter-organizational trust link, an authentication server and a supplicant must belong to the same organization, and the authenticator, which is from another organization, must have direct connectivity (i.e., in terms of transmission adjacency) with the authentication server and the supplicant. Therefore, this method is not practical in environments with dynamic network topology (e.g., an incident scene).

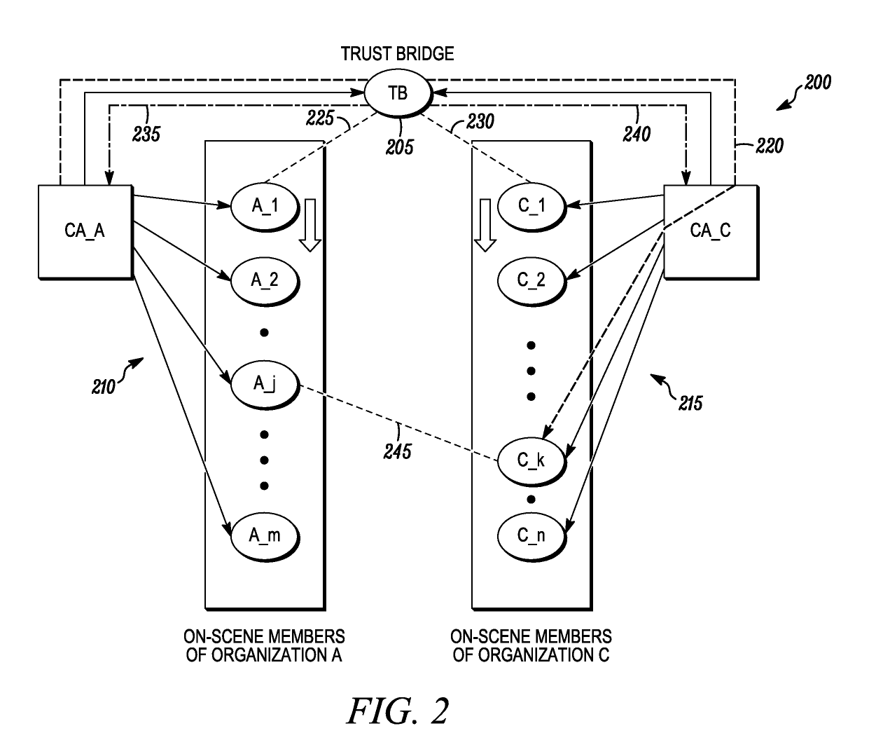

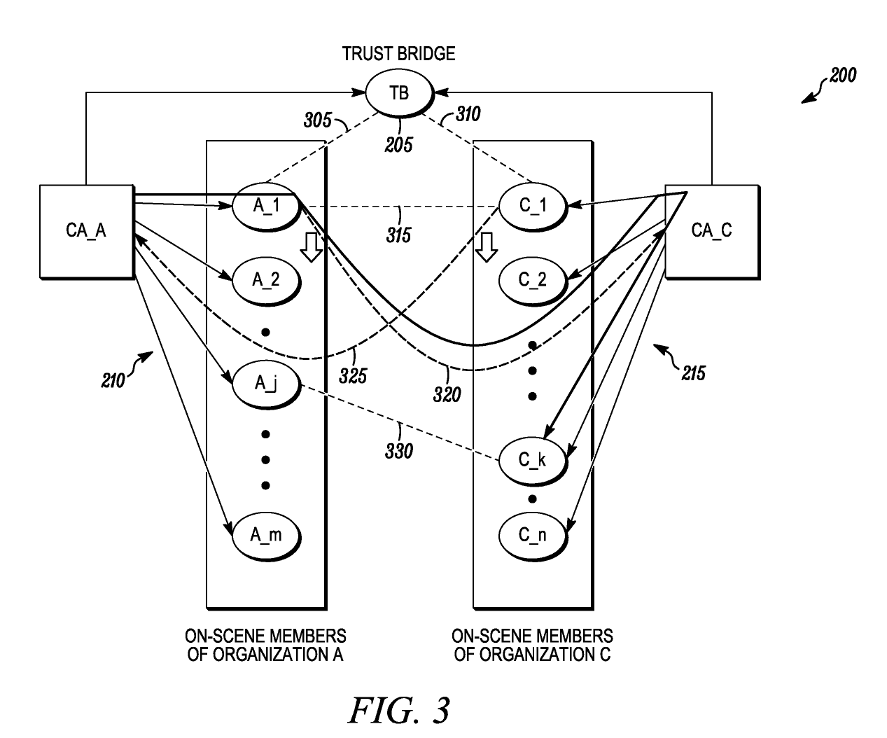

In light of the above further discussion of, examples of specific embodiments of the present invention are provided below with reference to FIG. 2 and FIG. 3.

Referring to FIG. 2, a diagram illustrates interactions for establishing trust between nodes of two different organizations in an ad hoc wireless communication network 200, according to some embodiments of the present invention. An organization A, which includes member nodes A_1 to A_m, seeks to establish trust with an organization C, which includes member nodes C_1 to C_n. Organization A has a certification authority CA_A trusted by all members of organization A, and organization C has a certification authority CA_C trusted by all members of organization C. Further, an inter-organizational trust establishment device in the form of a trust bridge 205 has been preconfigured with trust anchors associated with both organizations. That is, the trust bridge 205 is provided with corresponding certification authority (CA) public keys that are known and trusted in advance, and the trust bridge 205 is issued self-signed CA certificates. Further, the trust bridge 205 is issued a certificate signed by each of the certification authorities CA_A and CA_C. Also, these certificates of the trust bridge 205 signed by CA_A and CA_C are denoted, respectively, by B_A and B_C. The certificate B_A contains an identity of the trust bridge 205 and a public key of the trust bridge 205 recognized and vouched for by CA_A; and the certificate B_C contains the identity of the trust bridge 205 and a public key of the trust bridge 205 recognized and vouched for by CA_C.

Alternatively, the trust bridge 205 can be provided with the public keys by means other than issuing corresponding CA certificates. For example, the trust bridge 205 could create a certificate equivalent element for each of CA_A and CA_C, wherein a certificate equivalent element for a CA contains at least an identity and a public key of the CA. Further, the certificate equivalent element could contain predetermined context-dependent information not typically found in a CA certificate (e.g., an incident identifier that limits the validity of the element to a particular incident). Hereinafter, the certificates or corresponding certificate equivalent elements of CA_A and CA_C are denoted by T_A and T_C, respectively, where T indicates a trust anchor.

Intra-organizational trust is established within each organization A and C based on transitive trust through respective certification authorities. That means that the member nodes A_1 to A_m of organization A are readily able to establish trust links among themselves, and the member nodes C_1 to C_n are also able to establish trust links among themselves. Moreover, each member node of an organization has been provided with a certificate of the CA of that organization, or otherwise can create a certificate equivalent element for the CA. For example, as shown by arrows 210, each member node A_1 to A_m of organization A has received a certificate from CA_A, thereby having a certification path from CA_A to each of the member nodes of organization A. Similarly, as shown by arrows 215, each member node C_1 to C_n of organization C has received a certificate from CA_C, thereby having a certification path from CA_C to each of the member nodes of organization C.

The trust bridge 205 is used to establish a certification path from a member node of a first organization (either A or C) to a CA of a second organization (either C or A, respectively) such that a member node of the second organization can authenticate and establish an inter-organizational trust link with the member node of the first organization. Specifically, the certification path traverses the CA of the first organization and the trust bridge 205. For example, as described in more detail below, one particular certification path from CA_A is illustrated by the dotted line 220.

Establishment of the certification path from CA_A employs the following steps. First, the trust bridge 205 cross-signs certificate T_A with a private key of the trust bridge 205 corresponding to its public key contained in certificates B_C and T_C with another private key of the trust bridge 205 corresponding to its public key contained in certificate B_A. Next, the trust bridge 205 establishes a trust link with a selected member node (e.g., A_1) in organization A and another trust link with a selected member node (e.g., C_1) in organization C. These trust links are represented by the dashed lines 225, 230, respectively. (The dashed lines 225, 230 do not include arrows because they do not represent certification paths.) Also, dashed lines 235, 240 indicate that the trust bridge 205 has signed, respectively, a certificate of CA_A and a certificate of CA_C, thereby having a certification path from the trust bridge 205 to each of CA_A and CA_C.

Next, the trust bridge 205 forwards the cross-signed certificate T_C to node C_1 through the established trust link between the trust bridge 205 and node C_1. Similarly, the trust bridge 205 forwards the cross-signed certificate T_A to node A_1 through the established trust link between the trust bridge 205 and node A_1. In addition, the trust bridge 205 forwards certificate B_A signed by CA_A to node C_1 and certificate B_C signed by CA_C to node A_1. Node A_1 and node C_1 then distribute certificates T_A and T_C (both cross-signed by the trust bridge 205), respectively, to on-scene members of their organizations in accordance with predetermined trust propagation policy.

Subsequently, when node A_j communicates with node C_k, as illustrated by the dashed line 245, a trust link can be established between them as follows: First, node C_k presents to node A_j the following chain of certificates:
Node C_k's own certificate signed by CA_C;
Certificate T_C cross-signed by the trust bridge 205 (with respect to certificate B_A); and
Certificate B_A signed by CA_A.
   Given these certificates, node A_j is then able to construct the certification path illustrated by the line 220: CA_A→trust bridge 205 (with respect to B_A)→CA_C→C_k. Because node A_j trusts CA_A, node A_j can then trust node C_k. Similarly, node C_k is able to construct a certification path from node A_j back to CA_C.

Some embodiments of the present invention thus provide a scalable and robust method for establishing inter-organizational trust for securing communication between on-scene members of different organizations at an incident scene. Embodiments leverage trust bridging as well as mechanisms of localized cross-certification and key distribution to establish trust between members of two autonomous organizations. Specifically, after any two devices of different organizations have established trust between them through a trust bridge, embodiments of the present invention enable such trust to be extended to each device's respective organization member population at an incident scene subject to predetermined policy. As described above, there is a pre-established intra-organizational trust among all devices within each organization (e.g., through certificate-based authentication with certificates issued by a corresponding certification authority (CA)).

The ad hoc wireless communication network 200, for example, can comprise a mesh enabled architecture (MEA) network or an 802.11 network (i.e., 802.11a, 802.11b, 802.11g, 802.11n or 802.11s). It will be appreciated by those of ordinary skill in the art that the ad hoc wireless communication network 200 can alternatively comprise any packetized communication network where packets are forwarded across multiple wireless hops. For example, the ad hoc wireless communication network 200 can be a network utilizing multiple access schemes such as OFDMA (orthogonal frequency division multiple access), TDMA (time division multiple access), FDMA (Frequency Division Multiple Access), or CSMA (Carrier Sense Multiple Access).

According to some embodiments of the present invention, a trust bridge such as the trust bridge 205 is configured with trust anchors associated with two organizations. That means that the trust bridge is provided with corresponding CA public keys that are known and trusted in advance by issuing to the trust bridge self-signed CA certificates. The trust bridge is also configured with a certificate signed by each of the CAs.

As illustrated in FIG. 2, according to some embodiments the trust bridge 205 cross-signs the certificates of the CAs of a first organization (A) and a second organization (C), and then securely forwards the cross-signed CA certificates to two devices (such as node A_j and node C_k) that have already established trust between themselves and the trust bridge 205. The cross-signed CA certificates are then distributed among other member nodes of organizations A and C. A device in one organization is then able to present to a relying party in the other organization information needed to construct a certification path to the CA of the relying party, wherein the certification path traverses the CA of the other organization as well as the trust bridge.

Referring to FIG. 3, a diagram illustrates alternative interactions for establishing trust between nodes of two different organizations in the ad hoc wireless communication network 200, according to some embodiments of the present invention. Consider again that the organization A, which includes member nodes A_1 to A_m, seeks to establish trust with the organization C, which includes member nodes C_1 to C_n. Further, the trust bridge 205 has been preconfigured with trust anchors associated with both organizations.

The embodiments illustrated in FIG. 3 employ a trust bridge to establish a certification path from a member of a first organization to a CA of a second organization such that a member of the second organization can be authenticated and an inter-organizational trust link can be established with the member of the first organization. Specifically, the certification path traverses the CA of the first organization and a selected member of the second organization, wherein the selected member of the second organization has previously established trust with a selected member of the first organization via the trust bridge.

For example, the following steps are performed: The trust bridge 205 establishes trust links with a selected member (e.g., A_1) in organization A and a selected member (e.g., C_1) in organization C. These trust links, which are illustrated by the dashed lines 305, 310, respectively, are used to enable secure communications between the trust bridge 205 and each of the selected members (i.e., A_1 and C_1). Next, the pair of selected members, having respectively established trust links with the trust bridge 205, obtain service from the trust bridge 205 to set up a trust link, illustrated by dashed line 315, between them.

Next, node A_1 and node C_1 securely exchange certificates T_A and T_C. Node A_1 then signs certificate T_C with node A_1's private key corresponding to its public key contained in node A_1's certificate, and then returns the signed certificate T_C to node C_1 over the established trust link. Similarly, node C_1 signs certificate T_A with node C_1's private key corresponding to its public key contained in node C_1's certificate, and then returns the signed certificate T_A to node A_1 over the established trust link. Dashed line 320 with an arrow represents a certification path from A_1 to CA_C, and dashed line 325 with an arrow represents a certification path from C_1 to CA_A.

Node A_1 then distributes certificate T_A signed by node C_1 and node C_1's certificate signed by CA_C to other on-scene members (or selected members justified by predetermined need) of organization A in accordance with predetermined trust propagation policy. Similarly, node C_1 distributes certificate T_C signed by node A_1 and node A_1's certificate signed by CA_A to on-scene members (or selected members justified by predetermined need) of organization C in accordance with predetermined trust propagation policy.

Subsequently, when node A_j communicates with node C_k, as illustrated by dashed line 330, a trust link can be established between them as follows. First, node C_k presents to node A_j the following chain of certificates:
Node C_k's own certificate signed by CA_C;
Certificate T_C signed by node A_1; and
Node A_1's certificate signed by CA_A.
   Given these certificates, node A_j is able to construct a certification path: CA_A→A_1→CA_C→C_k. Since node A_j trusts CA_A and has previously established intra-organizational trust with node A_1, node A_j can trust node C_k. Similarly, node C_k is able to construct a certification path from node A_j back to CA_C.

According to still other embodiments of the present invention, a method for establishing trust between nodes of two different organizations in the ad hoc wireless communication network 200 can include the following. First, the trust bridge 205 establishes secure communication with a selected member node (e.g., A_1) in organization A and a selected member node (e.g., C_1) in organization C. The pair of selected members, having respectively established trust links with the trust bridge 205, obtains service from the trust bridge 205 to set up a trust link between them. Next, A_1 and C_1 jointly or independently establish keying material for each inter-organizational link by connecting a pair of on-scene members in their respective organizations A and C, and A_1 and C_1 then distribute appropriate keying material to on-scene members of their own organization A and C, respectively, in accordance with predetermined trust propagation policy.

There are m*n inter-organizational trust links in the ad hoc wireless communication network 200. Using conventional asymmetric key cryptography, one would need to securely distribute m+n private keys to m+n individual devices and corresponding m+n public keys to the m+n devices. Using conventional symmetric key cryptography, one would need to distribute m*n secret keys to m*n pairs of communicating devices. If a lower level of security is acceptable, one could resort to a single secret number (e.g., a passcode) for protecting all m*n pair-wise communications from external intrusion.

According to some embodiments of the present invention, a known method of cryptographic key management can be used, as published, for example, in He, Wenbo; Huang, Ying; Nahrstedt, Klara; Lee, Whay C., “SMOCK: A Self-Contained Public Key Management Scheme for Mission-Critical Wireless Ad Hoc Networks”, Fifth Annual IEEE International Conference on Pervasive Computing and Communications (PerCom), 19-23 March 2007, pages 201-210; and in Wenbo He; Ying Huang; Sathyam, R.; Nahrstedt, K.; Lee, W. C., “SMOCK: A Scalable Method of Cryptographic Key Management for Mission-Critical Wireless Ad-Hoc Networks”, IEEE Transactions on Information Forensics and Security, March 2009, Volume 4, Issue 1, pages 140-150. The method is an asymmetric key distribution method that combines more than one key to encrypt and decrypt a message. Specifically, a predetermined set of distinct public keys are used to encrypt a message before it is delivered by the sender, such that the message can be decrypted only with a corresponding subset of distinct private keys (referred to as a key-set). The devices share all the public keys. With optimal design, the size of a key-set can be much smaller than the total number of keys. The method is thus scalable due to combinatorial design.

For example, using the above described method of cryptographic key management in the ad hoc wireless communication network 200, node A_1 will first generate a set of public-private key pairs for local inter-organizational trust establishment. Node A_1 then securely sends a distinct key-set to each member node selected to establish trust with members of organization C. For each member node assigned a key-set, node A_1 maintains a record of the member node's key-set association (used to determine which subset of public keys to use for decrypting a message from the member node). Next, A_1 will securely distribute this record and the set of public keys to C_1 and to other member nodes of organization A. Node C_1 will carry out similar steps. When an additional member needs to be assigned a key-set, there is no need to securely distribute a new public key, as long as there is at least one unassigned key-set. However, an updated record of members' key-set association is securely distributed.

In still other embodiments, node A_1 and node C_1 jointly generate a set of m*n symmetric keys and associate with each key an ordered pair of identifiers. Each ordered pair of identifiers consists first of an identifier of an on-scene member of organization A and second of an identifier of an on-scene member of organization C. For each on-scene member of organization A, node A_1 securely transmits a set of keys corresponding to ordered identifier pairs, each with the identifier of that on-scene member of organization A as the first associated identifier. Similarly, for each on-scene member of organization C, node C_1 securely transmits a set of keys corresponding to ordered identifier pairs, each with the identifier of that on-scene member of organization C as the second associated identifier. Subsequently, a member node A_j of organization A can authenticate itself to a member node C_k of organization C by node A_j using the key it has received from node A_1. In that case, node C_k's identifier is the second associated identifier (and node A_j's identifier is the first associated identifier). Node C_k will correspondingly use the key it has received from node C_1, wherein node A_j's identifier is the first associated identifier. These keys will be the same.

In yet other embodiments, location-limited channels exist among trusted member nodes to help distribute a shared secret. As known by those having ordinary skill in the art, such location-limited channels are described, for example, in N. Asokan and P. Ginzboorg, “Key Agreement in Ad Hoc Networks”, Computer Communications, vol. 23, no. 17, November 2000; and in D. Balfanz, D. Smetters, P. Stewart, and H. Wong, “Talking to Strangers: Authentication in Ad Hoc Wireless Networks,” in Proc. 9th Annual Network and Distributed System Security Symposium, 2002.

Where such location-limited channels exist, node A_1 and node C_1 first generate a group shared secret through the trust bridge 205. Node A_1 and node C_1 then move to a proximity, defined for example by a radio or infrared signal range, of their respective pre-authenticated on-scene member nodes and distribute the said group shared secret to them through a location-limited channel. For example, the pre-authentication process can be performed in a preplanning stage where node A_1 verifies the certificate of each on-scene member of organization A, and node C_1 verifies the certificate of each on-scene member of organization C. The location-limited channel can be, for example, a short-ranged communication technology such as infrared, or simply a whiteboard in a closed room. After the group shared secret is distributed, trusted members from one group can use a simple password-based authentication method to establish session keys with members from the other group. During a pre-authentication process, group initiators (e.g., node A_1 or node C_1) should ensure that the certificates of participating members will remain valid for a desired time period, such as an estimated duration of interaction of the two organizations at an incident scene. Therefore, a typical lifetime of the group shared secret is conditionally short.

According to the various embodiments described above, a device in an organization is generally responsible for propagating trust, i.e., distributing a cross-signed certificate or keying material within the organization in accordance with predetermined policy. Policy-based trust propagation in an organization is useful because it is undesirable to have wide-spread propagation, especially when the organization is large. For example, devices belonging to an organization but which are not on-scene at an incident may not be included in the propagation since they are not on active duty. Also, such devices often have access to a more reliable means for inter-organizational trust establishment.

Therefore, various embodiments of the present invention may employ the following approaches to control the scope of trust propagation within an organization. Generally, propagation is executed via hop-by-hop forwarding of propagation messages within an ad hoc wireless communication network serving the organization. Where secret information is to be propagated, members within an organization are readily able to establish trust links among themselves.

A first approach is called proximity-based trust propagation. In this approach, trust propagation is limited to an area around the source of propagation. In one embodiment, propagation information is distributed via broadcast messages that are subject to a predetermined constraint on hop-count or time-to-live. In another embodiment, where location capability is available in each device, propagation messages are confined to a geographical area defined by a maximum distance from the source of propagation

A second approach is called command-based trust propagation. In this approach, trust propagation is constrained by a predetermined command structure within the organization. The command structure can be hierarchical with a tree-based relationship among all devices. Thus each device typically has a parent device and one or more child devices. Devices that have a common parent device are referred to as peer devices. According to some embodiments, each device, upon receiving a propagation message, distributes the propagation message to a subset of all of its child devices as well as its parent device. An incident scene context (e.g., whether a device is deployed on-scene or not) may be used to determine which subset of child devices should receive the propagation message.

Certificate revocations also can be managed in various ways. For example, if the certificate of the trust bridge 205 is revoked by CA_A, CA_A will distribute an updated certification revocation list (CRL) to all members of organization A. Upon receiving the updated CRL, node A_1 will forward it to node C_1, which in turn is responsible for propagating the CRL within organization C. Similarly, if the certificate of the trust bride 205 is revoked by CA_C, an updated CRL will be distributed by CA_C to all members of organization C. Upon receiving the updated CRL, node C_1 will forward it to node A_1, which in turn is responsible for propagating it within organization A. If the certificate of the trust bridge 205 is revoked by either CA_A or CA_C, all inter-organizational trust links previously established through the trust bridge 205 will have to be deconstructed and reestablished through another trust bridge.

If a certificate of node A_1 or node C_1 is revoked, the trust bridge 205, which was originally involved in establishing trust between node A_1 and node C_1 will take the responsibility of alerting on-scene member nodes of organization A and organization C. The trust bridge 205 can do so by first authenticating with any on-scene member node in each organization A and C and then securely transmitting an alert to that on-scene member node for intra-organization propagation.

For example, if node C_k's certificate (k≠1) is revoked, the trust bridge 205 and node C_1 will learn about such revocation from an updated CRL issued by CA_C. According to embodiments illustrated by FIG. 2, the trust bridge 205 will be responsible for forwarding the updated CRL to node A_1 so that node A_1 can propagate the updated CRL within organization A. According to embodiments illustrated by FIG. 3, node C_1 will be responsible for forwarding the updated CRL to node A_1 so that node A_1 can propagate the updated CRL within organization A. Similarly, if node A_j's certificate (k≠1) is revoked, the trust bridge 205 and node A_1 will learn about it from an updated CRL issued by CA_A. According to embodiments illustrated by FIG. 2, the trust bridge 205 will be responsible for forwarding the updated CRL to node C_1 so that node C_1 can propagate the updated CRL within organization C. According to embodiments illustrated by FIG. 3, node A_1 will be responsible for forwarding the updated CRL to node C_1 so that node C_1 can propagate the updated CRL within organization C.

Where embodiments use a group shared secret or a set of symmetric keys, these cryptographic elements are generally short-lived, wherein their validity periods are typically much shorter than a CRL update cycle. Thus where symmetric key distribution mechanisms are used, the cryptographic operations involved are more efficient but revocation may not normally be available.

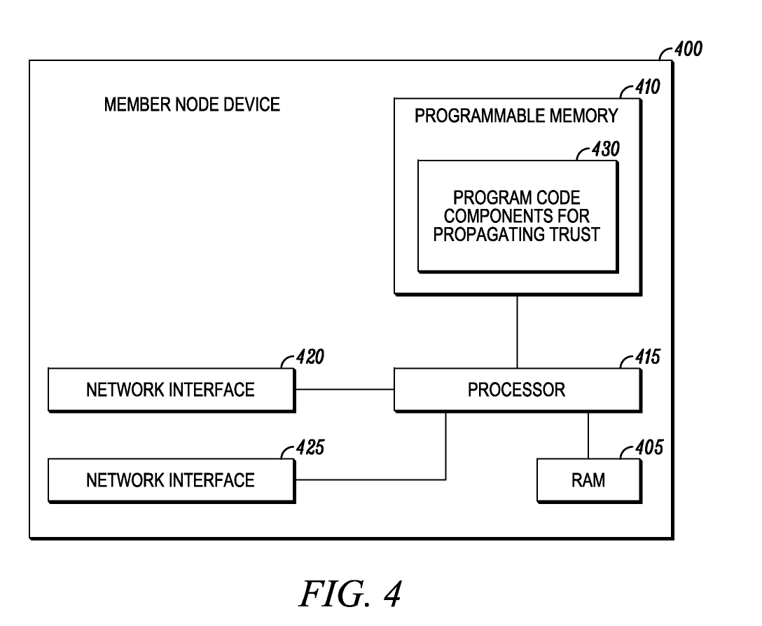

Referring to FIG. 4, a block diagram illustrates components of a device 400 that functions as a member node in the wireless communication network 200, according to some embodiments of the present invention. For example, the device 400 can comprise one of the member nodes of organization A or C, such as member node A_1 or member node C_1. The device 400 can be an integrated unit such as a computer, mobile telephone, handheld radio, or personal digital assistant (PDA) containing at least all the elements depicted in FIG. 4, as well as any other elements necessary for the device 400 to perform its particular functions. Alternatively, the device 400 can comprise a collection of appropriately interconnected units or devices, wherein such units or devices perform functions that are equivalent to the functions performed by the elements depicted in FIG. 4.

The device 400 comprises a random access memory (RAM) 405 and a programmable memory 410 that are coupled to a processor 415. The processor 415 also has ports for coupling to network interfaces 420, 425. The network interfaces 420, 425, which for example may be wireless network interfaces, can be used to enable the device 400 to communicate with other node devices in a communication network.

The programmable memory 410 can store operating code (OC) for the processor 415 and code for performing functions associated with a network device. For example, the programmable memory 410 can store computer readable program code components 430 configured to cause execution of a method for propagating trust between a first organization and a second organization operating in an ad hoc wireless communication network, as described herein. Further, multiple devices 400 operated by a first organization, such as the member node A_1 and the member node A_j operated by organization A, can function together to define a system for propagating trust between the first organization and a second organization operating in an ad hoc wireless communication network.

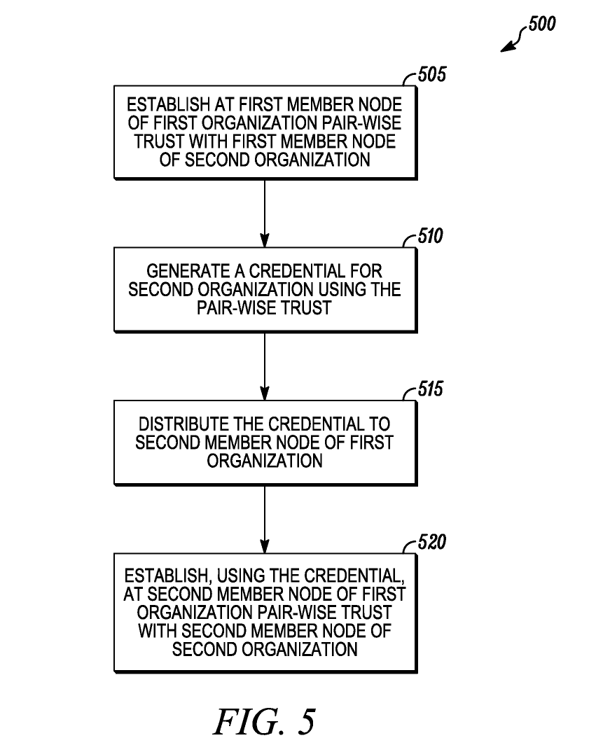

Referring to FIG. 5, a general flow diagram illustrates a method 500 for propagating trust between a first organization and a second organization, both operating in an ad hoc wireless communication network, according to some embodiments of the present invention. First, at step 505, a first member node of the first organization establishes pair-wise trust with a first member node of the second organization using a predetermined inter-organizational trust establishment device. For example, in the ad hoc wireless communication network 200, the member node A_1 of organization A establishes pair-wise trust with the member node C_1 of organization C using the trust bridge 200.

At step 510, the first member node of the first organization generates a credential for the second organization using the pair-wise trust. For example, the member node A_1 of organization A generates a credential by performing one of the following steps: signing a certificate of a certification authority of organization C; signing a certificate equivalent element of organization C; receiving from a member node of organization C a certificate of a certification authority of organization C and signing the certificate; receiving from a member node of organization C a certificate equivalent element of organization C and signing the certificate equivalent element; or generating keying material for establishing pair-wise trust between another member node of organization A and another member node of organization C.

At step 515, the credential is distributed from the first member node of the first organization to a second member node of the first organization. For example, the member node A_1 of organization A distributes the credential to member node A_j of organization A.

At step 520, the second member node of the first organization establishes pair-wise trust with a second member node of the second organization using the credential received from the first member node of the first organization. For example, the member node A_j of organization A establishes pair-wise trust with member node C_k of organization C using the credential received from member node A_1 of organization A.

Some embodiments of the present invention thus provide a method to establish trust among devices having certificates signed by different certification authorities in an ad hoc wireless communication network in a scalable and robust manner. Specifically, after any two devices of different organizations have established trust between them by using a trust bridge, the method enables such trust to be extended to their respective organization member population subject to predetermined policy. The method leverages trust bridging as well as localized cross-certification and key distribution mechanisms to establish inter-organizational trust between members of two autonomous organizations. Where localized cross-certification is used, it is implicit that a CA certificate or certificate equivalent elements cross-signed by a trust bridge or a member of an organization are not as trustworthy as a CA certificate that is cross-signed by another CA. By allowing a member of an organization to cross-sign a CA certificate, the validity of the certificate and scope of authority imparted to a certificate holder is limited. Validity of the certification may, for example, be subject to time and space constraints. Scope of authority may be governed by a predetermined policy. In view of the limited validity and scope, some embodiments disallow renewal or update of the cross-signed certificates. However, the cross-signed certificates may be extended to newly joined devices as long as the certificate validity periods have not expired.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the present teachings. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, or contains a list of elements does not include only those elements but may include other elements not expressly listed or inherent to such process, method, article, or apparatus. An element preceded by “comprises a ”, “has a . . . ”, “includes a . . . ”, or “contains a . . . ” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The terms “coupled” or “connected” as used herein define a connection that is not necessarily direct but may be indirect. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and system described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for propagating trust between a first organization and a second organization, both operating in an ad hoc wireless communication network, the method comprising:
establishing at a first member node of the first organization pair-wise trust with a first member node of the second organization using a predetermined inter-organizational trust establishment device;
generating at the first member node of the first organization a credential for the second organization using the pair-wise trust;
distributing the credential from the first member node of the first organization to a second member node of the first organization; and
establishing at the second member node of the first organization pair-wise trust with a second member node of the second organization using the credential received from the first member node of the first organization.

2. The method of claim 1, wherein the predetermined inter-organizational trust establishment device is configured with a certification authority certificate of the first organization, a certification authority certificate of the second organization, a certificate signed by the certification authority of the first organization, and a certificate signed by the certification authority of the second organization.

3. The method of claim 1, wherein the predetermined inter-organizational trust establishment device is configured with a certification authority certificate of the first organization, a certification authority certificate of the second organization, and a certificate signed by both the certification authority of the first organization the certification authority of the second organization.

4. The method of claim 1, wherein the predetermined inter-organizational trust establishment device is configured with a first certificate equivalent element for a certification authority of the first organization and a second certificate equivalent element for a certification authority of the second organization, wherein the certificate equivalent element for a certification authority contains at least an identity and a public key of the certification authority.

5. The method of claim 1, wherein generating at the first member node of the first organization the credential for the second organization using the pair-wise trust comprises:
signing a certificate of a certification authority of the second organization, or signing a certificate equivalent element of the second organization.

6. The method of claim 1, wherein generating at the first member node of the first organization the credential for the second organization using the pair-wise trust comprises:
receiving at the first member node of the first organization from the first member node of the second organization received material comprising either a certificate of the certification authority of the second organization or a certificate equivalent element of the second organization; and
signing the received material.

7. The method of claim 1, wherein generating at the first member node of the first organization the credential for the second organization using the pair-wise trust comprises:
generating keying material for establishing pair-wise trust between a second member node of the first organization and a second member node of the second organization.

8. The method of claim 7, wherein the keying material comprises asymmetric cryptographic keys.

9. The method of claim 7, wherein the keying material comprises symmetric cryptographic keys.

10. The method of claim 7, wherein the keying material comprises a group shared secret between the first organization and the second organization.

11. The method of claim 1, wherein distributing the credential from the first member node of the first organization to a second member node of the first organization comprises transmitting the credential through a third member node of the first organization.

12. The method of claim 1, wherein distributing the credential from the first member node of the first organization to a second member node of the first organization comprises broadcasting the credential in a message subject to a predetermined constraint on at least one of hop-count, time-to-live, and distance from a source of propagation.

13. The method of claim 1, wherein distributing the credential from the first member node of the first organization to a second member node of the first organization comprises broadcasting the credential in a message constrained by a predetermined command structure within the first organization.

14. The method of claim 1, further comprising distributing a certificate revocation list (CRL) from the first member node of the first organization to the second member node of the first organization after a certificate of the inter-organizational trust establishment device is revoked.

15. A system for propagating trust between a first organization and a second organization, both operating in an ad hoc wireless communication network, the system comprising:
a first member node of the first organization, comprising:
a first processor; and
a first memory coupled to the first processor, wherein the first memory includes computer readable program code components for:
establishing at the first member node of the first organization pair-wise trust with a first member node of the second organization using a predetermined inter-organizational trust establishment device;
generating at the first member node of the first organization a credential for the second organization using the pair-wise trust; and
distributing the credential from the first member node of the first organization to a second member node of the first organization; and
the second member node of the first organization, comprising:
a second processor; and
a second memory coupled to the second processor, wherein the second memory includes computer readable program code components for:
establishing at the second member node of the first organization pair-wise trust with a second member node of the second organization using the credential received from the first member node of the first organization.

16. The system of claim 15, wherein the predetermined inter-organizational trust establishment device is configured with a certification authority certificate of the first organization, a certification authority certificate of the second organization, a certificate signed by the certification authority of the first organization, and a certificate signed by the certification authority of the second organization.

17. The system of claim 15, wherein the predetermined inter-organizational trust establishment device is configured with a certification authority certificate of the first organization, a certification authority certificate of the second organization, and a certificate signed by both the certification authority of the first organization the certification authority of the second organization.

18. The system of claim 15, wherein the predetermined inter-organizational trust establishment device is configured with a first certificate equivalent element for a certification authority of the first organization and a second certificate equivalent element for a certification authority of the second organization.

19. The system of claim 15, wherein generating at the first member node of the first organization the credential for the second organization using the pair-wise trust comprises:
signing a certificate of a certification authority of the second organization, or signing a certificate equivalent element of the second organization.

20. The system of claim 15, wherein generating at the first member node of the first organization the credential for the second organization using the pair-wise trust comprises:
receiving at the first member node of the first organization from the first member node of the second organization received material comprising either a certificate of the certification authority of the second organization or a certificate equivalent element of the second organization; and
signing the received material.
